(19) United States
(12) Patent Application Publication
(10) Pub. No.: US 2013/0305588 A1
(43) Pub. Date: Nov. 21, 2013

(54) APPARATUS AND METHOD FOR KILLING FLYING INSECTS

(71) Applicant: Gary Victor Cann, Broome (AU)

(72) Inventor: Gary Victor Cann, Broome (AU)

(73) Assignee: ELECTRICANN PTY LIMITED, Broome (AU)

(21) Appl. No.: 13/981,329

(22) PCT Filed: Jan. 25, 2012
(86) PCT No.: PCT/AU2012/000061

§ 371 Date: Jul. 24, 2013

(30) Foreign Application Priority Data
Jan. 25, 2011 (AU) 2011900220

(51) Int. Cl. A01M 1/20; A01M 1/10

(52) U.S. Cl. CPC A01M 1/2016; A01M 1/106
USPC 43/122; 43/132.1; 43/131

(57) ABSTRACT

An apparatus (10) for killing flying insects comprises an open framework (12) having a lower portion (14) adapted to be located under ground level so as to define an in-ground enclosure, and an upper portion (16) which is adapted to be located above ground level and is continuous with the lower portion. The lower portion of the open framework includes a mesh (20) to prevent collapse of the ground around the enclosure. The apparatus (10) also includes means (24, 26) for spraying controlled amounts of insecticide into the in-ground enclosure, and a lid (22) for covering the top of the upper portion. In use, flying insects, such as sand flies and mosquitoes, may gain access into the in-ground enclosure by entering through an opening (28) in the open framework at the sides of the upper portion, and any such flying insects within the in-ground enclosure are killed by exposure to sprayed insecticide.

### TECHNICAL FIELD

The present invention relates to an apparatus and a method for killing flying insects and, in particular, to an in-ground trap for killing sand flies and other flying insects which are attracted to holes in the ground, such as for breeding purposes.

Although the background, objects and preferred embodiments of the invention will be hereinafter described with reference to a sand fly trap, it is to be understood that the invention is not limited thereto but has wider application. For example, the trap may be used for killing mosquitoes and other flying insects that may be attracted to in-ground enclosures.

It is to be understood that the terminology employed herein is for the purpose of description only and should not be regarded as limiting. For instance, the terms “comprising” or “comprises” are to be understood as meaning “including”, unless otherwise stated. Also, the term “trap” is to be understood as including any apparatus, whether or not it is intended to permanently catch, such as by a bait or lure, a flying insect, which is able to expose the insect to conditions that will cause its death whilst it is within an enclosed space in the ground.

### BACKGROUND ART

Sand flies are a common problem in parts of Australia, and particularly in the more northern or sandy areas, where their bite can be very unpleasant and may transmit the protozoal disease Leishmaniasis.

There is presently very little data on the extent of breeding sites in Australia, although these are generally considered to be within sensitive ecological environments where the widespread use of insecticides, such as DEET, is not supported as it is highly likely to cause serious environmental harm.

No effective treatment process exists to prevent these insects breeding and travelling to the nearest “blood meal”. Some species can travel up to three kilometres from the breeding sites in search of a “blood meal”. The best remedies for such pests are to ensure that human residences are not located close to breeding sites. Currently, only topical repellents and screening of buildings can provide a measure of protection to humans already located in affected areas.

A sensible precaution to prevent biting insect attack is to avoid areas that are known to have high biting insect activity. Extensive areas of mangroves or estuarine areas with sandy beaches are potential sources of sand flies and generally residents within 400 m of the breeding area can be exposed to them.

However, human avoidance of sand flies is not always possible given that sand flies are often found in desirable holiday destinations and locations where building works may occur.

There is therefore a need for an environmentally safe, effective and easy to install solution to the problem of sand flies that can be employed by local communities at minimum cost to control flying insect populations to acceptable levels.

### DISCLOSURE OF INVENTION

It is, therefore, an object of the present invention to overcome or substantially ameliorate the disadvantages and problems of the aforementioned prior art, or at least provide a useful alternative.

It has been found by the present inventor that these and other objects of the present invention may be achieved in general by providing an apparatus for killing flying insects comprising an open framework having a lower portion adapted to be located under ground level so as to define an in-ground enclosure, and an upper portion which is adapted to be located above ground level and is continuous with the lower portion, the lower portion of the open framework including a mesh to prevent collapse of the ground around the enclosure, means for spraying controlled amounts of insecticide into the in-ground enclosure, and a lid for covering the top of the upper portion, wherein flying insects, such as sand flies and mosquitoes, may gain access into the in-ground enclosure by entering through an opening in the open framework at the sides of the upper portion, whereby any flying insects within the in-ground enclosure are killed by exposure to sprayed insecticide.

Preferably, for larger apparatus, the insecticide is supplied to the spraying means through a pipe feeding from a pressurized insecticide storage vessel.

It is preferred that the insecticide is sprayed in controlled amounts through one or more nozzles located along a portion of the pipe inside the in-ground enclosure under the control of a timer.

Alternatively, for smaller apparatus, the insecticide is supplied from a single spray can and sprayed in controlled amounts through the nozzle of the can under the control of a timer.

Preferably, the timers of the larger and smaller apparatus are adjustable by the user. The insecticide is preferably sprayed as a mist from the or each nozzle. By way of example only, the upper portion has a height of about 200 mm above ground level, and the lower portion has a depth of about 400 mm below ground level.

In a preferred form, the apparatus includes at least one form of an attractant for flying insects, such as a container filled with water and/or a container filled with water, sugar and yeast (that produces carbon dioxide) to attract sand flies and mosquitoes. House flies may be attracted to the apparatus by including any known fly attractant, either liquid or solid, such as rotting food.

Optionally, the lid has a hole formed therethrough, and there is a tray located beneath the lid for capturing and pooling any water that passes through the hole, wherein the water in the tray serves to attract any flying insects, such as mosquitoes, into the in-ground enclosure.

In an alternative embodiment of the invention, the lid comprises a compartment having a floor and a roof extending upwardly from the sides of the floor, the floor having an opening formed therethrough to allow access of flying insects from the upper portion into the compartment, the roof being transparent, whereby any flying insects within the compartment are trapped therein and will die. Preferably, the sides of the roof extend upwardly from the outer edges of the floor and then meet across a valley shaped region. Such a lid may replace or augment the insecticide spraying means as a means by which any flying insects are killed by the apparatus.

In the aforementioned embodiment, the opening is preferably defined by a converging passageway from the upper portion to the compartment.

The floor of the compartment is preferably black, so as to attract certain flying insects, such as march flies.

The aforementioned lid may be operatively associated with a suction device or blower to remove dead or trapped insects from within the compartment.

In order to attract European wasps or similar flying insects to the apparatus, the lid is preferably yellow. Green light emitting diodes (LEDs) may also be included as specific attractants if required.

The lid may be secured to the top of the upper portion by bolts. In the larger apparatus, which will be most useful for certain commercial purposes, the lid is made of concrete for strength and fire proofing.

According to another aspect of the invention, there is provided a method for killing flying insects, comprising:
(a) providing an open framework having a lower portion adapted to be located under ground level, and an upper portion adapted to be located above ground level and which is continuous with the lower portion and has a lid for covering the top of the upper portion, the lower portion of the open framework including a mesh to prevent collapse of the ground into the lower portion,
(b) locating the lower portion under ground level so as to define an in-ground enclosure, and
(c) spraying controlled amounts of insecticide into the in-ground enclosure, wherein flying insects, such as sand flies and mosquitoes, which gain access into the in-ground enclosure by entering through an opening in the open framework at the sides of the upper portion are killed by exposure to sprayed insecticide.

There has been thus outlined, rather broadly, the more important features of the invention in order that the detailed description thereof that follows may be better understood and put into practical effect, and in order that the present contribution to the art may be better appreciated.

There are additional features of the invention that will be described hereinafter. As such, those skilled in the art will appreciate that the concept, upon which the disclosure is based, may be readily utilized as the basis for designing other assemblies and processes for carrying out the objects of the present invention. It is important, therefore, that the broad outline of the invention described above be regarded as including such equivalent constructions in so far as they do not depart from the spirit and scope of the present invention.

### BRIEF DESCRIPTION OF THE DRAWINGS

The invention will be better understood and objects other than those set forth above will become apparent when consideration is given to the following detailed description thereof. Such description makes reference to the accompanying drawings, in which:

FIG. 1 is a perspective view of an apparatus according to a first preferred embodiment of the invention,

FIG. 2 is a perspective view of an apparatus according to a second preferred embodiment of the invention,

FIG. 3 is a perspective, partially cut-away, exploded view of an apparatus according to a third preferred larger embodiment of the invention,

FIG. 4 is a perspective, ground cut-away, view of the open framework and lid (but absent the insecticide spraying means) of the apparatus shown in FIG. 3, located in the ground,

FIG. 5 is a side view of the open framework and lid shown in FIG. 4,

FIG. 6 is a perspective, exploded view of an open framework and lid (but absent the insecticide spraying means) of an apparatus according to a fourth preferred smaller embodiment of the invention,

FIG. 7 is a side, partially cut-away, view of the upper portion and a part of the lower portion of one side of the open framework shown in FIG. 6,

FIG. 8 is a side view of a preferred lid, with a water tray located beneath it, that can be used in the apparatus of FIGS. 1, 2, 3 and 6, and

FIG. 9 is a perspective, partially cut-away, exploded view of a preferred lid and suction device that can be used in the apparatus of FIGS. 1, 2, 3 and 6

### MODES FOR CARRYING OUT THE INVENTION

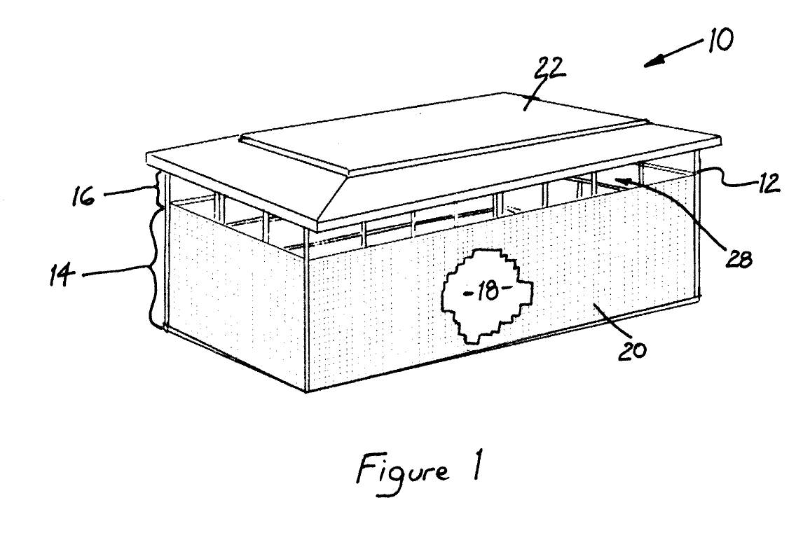

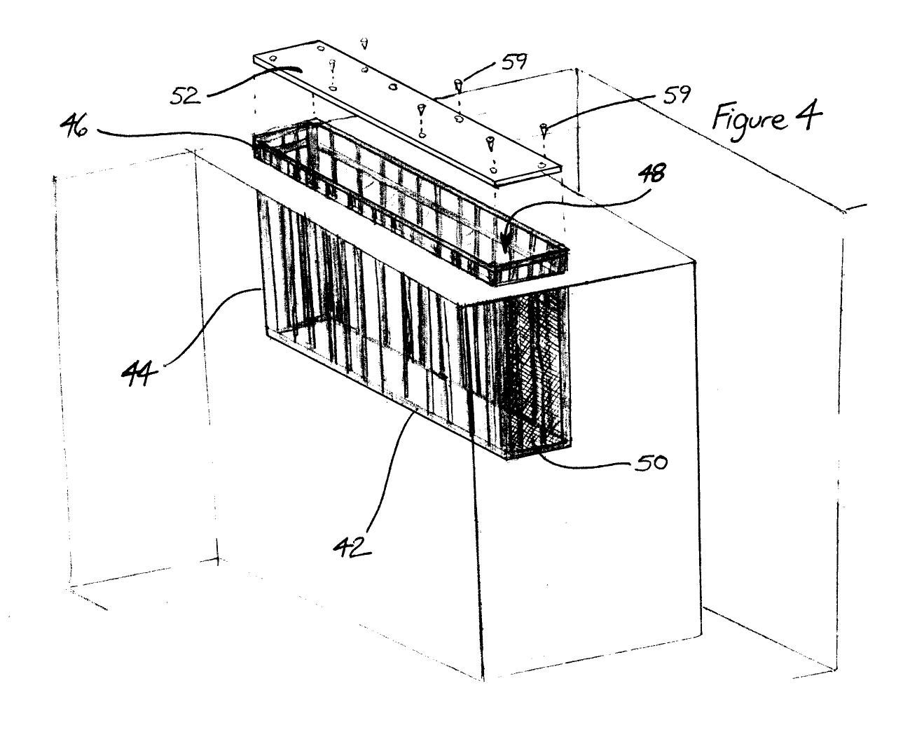

With reference now to the above summarized drawings of FIGS. 1 to 9, an apparatus and a method for killing flying insects, such as sand flies and mosquitoes, which embody the principles and concepts of the present invention, will now be described.

The apparatus 10 shown in FIG. 1 is adapted to be laid in a trench dug in the ground and comprises an open framework 12 having a lower portion 14 and an upper portion 16. When so located, the lower portion 14 is under ground level so as to define an in-ground enclosure 18, and the upper portion 16 is above ground level and is continuous with the lower portion. The lower portion 14 of the open framework has a mesh 20, which is preferably made of a plastic, connected across it to prevent collapse of the ground around the enclosure. There is also a removable lid 22 for covering the top of the upper portion 16. The apparatus 10 also includes means (not shown) for spraying controlled amounts of insecticide into the in-ground enclosure. In use, flying insects, such as sand flies and mosquitoes, which gain access into the in-ground enclosure 18 by entering through an opening 28 in the open framework 12 at the sides of the upper portion 16, are killed by exposure to sprayed insecticide.

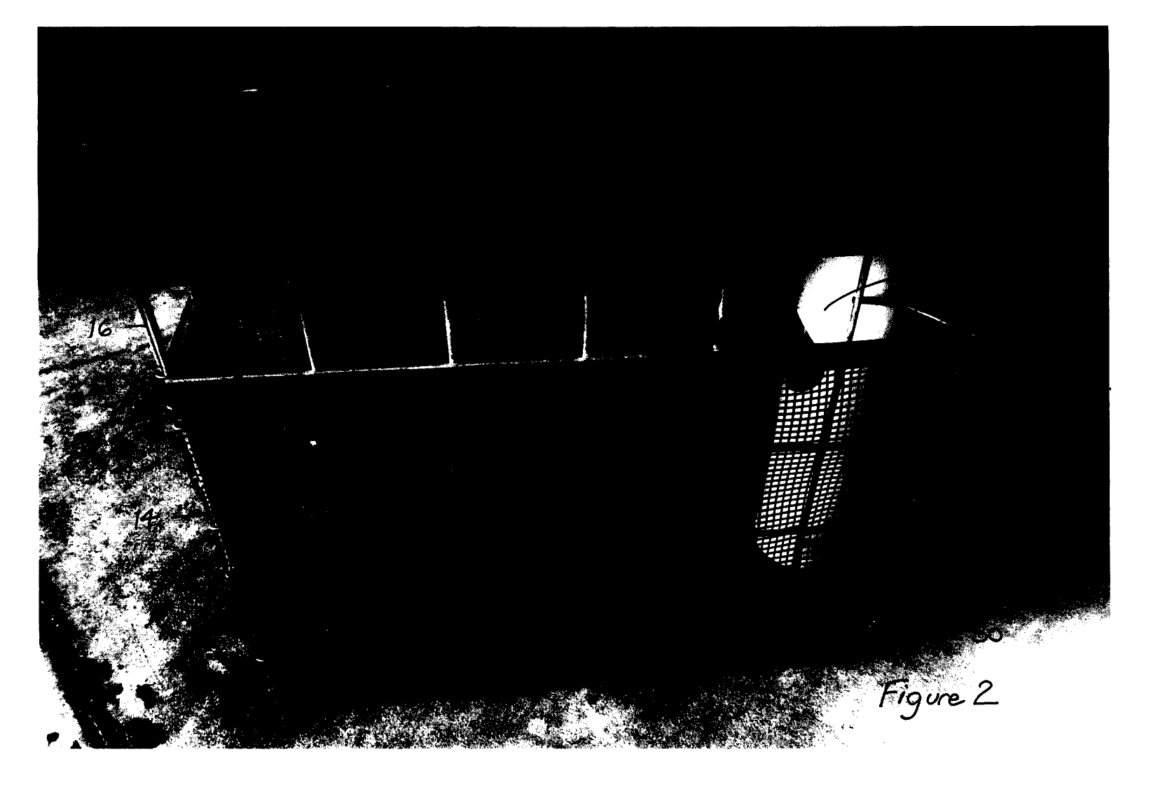

In the apparatus 30 shown in FIG. 2, which has similar features to apparatus 10 (for which features like numbers have been assigned), means 32 for spraying controlled amounts of insecticide into the in-ground enclosure 18 are shown. The insecticide is supplied from a single spray can (located in a holder) and is sprayed in controlled amounts through the nozzle of the can under the control of a timer (not shown).

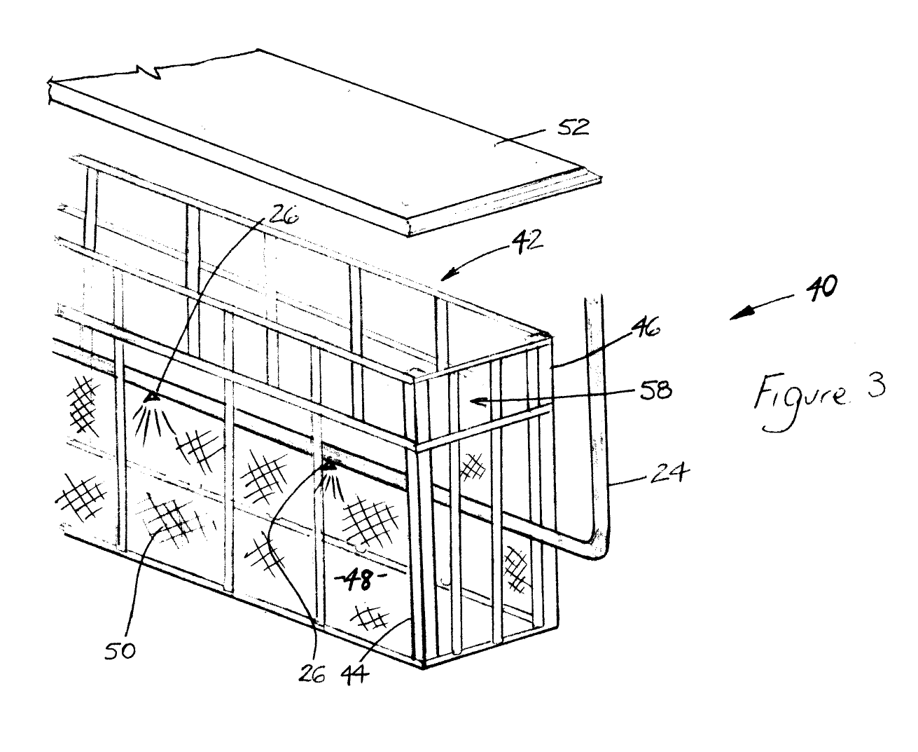

The apparatus 40 shown in FIGS. 3 to 5 is adapted to be laid in a trench dug in the ground and comprises an open framework 42 having a lower portion 44 and an upper portion 46. When so located, the lower portion 44 is under ground level so as to define an in-ground enclosure 48, and the upper portion 46 is above ground level and is continuous with the lower portion. The lower portion 44 of the open framework has a mesh 50 connected across it to prevent collapse of the ground around the enclosure. There is also a lid 52 for covering the top of the upper portion 46. The apparatus 40 also includes means 24, 26 for spraying controlled amounts of insecticide into the in-ground enclosure. In use, flying insects, such as sand flies and mosquitoes, which gain access into the in-ground enclosure 48 by entering through an opening 58 in the open framework 42 at the sides of the upper portion 46, are killed by exposure to sprayed insecticide.

In the apparatus 40, which is a larger apparatus that may be used for commercial purposes, the insecticide is supplied through a pipe 24 feeding from a pressurized insecticide storage vessel (not shown). The insecticide is sprayed in controlled amounts through a plurality of nozzles 26 located along a portion of the pipe 24 inside the in-ground enclosure 48 under the control of a timer (not shown).

In this embodiment, the upper portion 46 has a height of about 200 mm above ground level, and the lower portion 44 has a depth of about 400 mm below ground level.

The lid 52 is secured to the rails at the top of the upper portion 46 by bolts 59. For certain commercial purposes, the lid 52 is made of concrete.

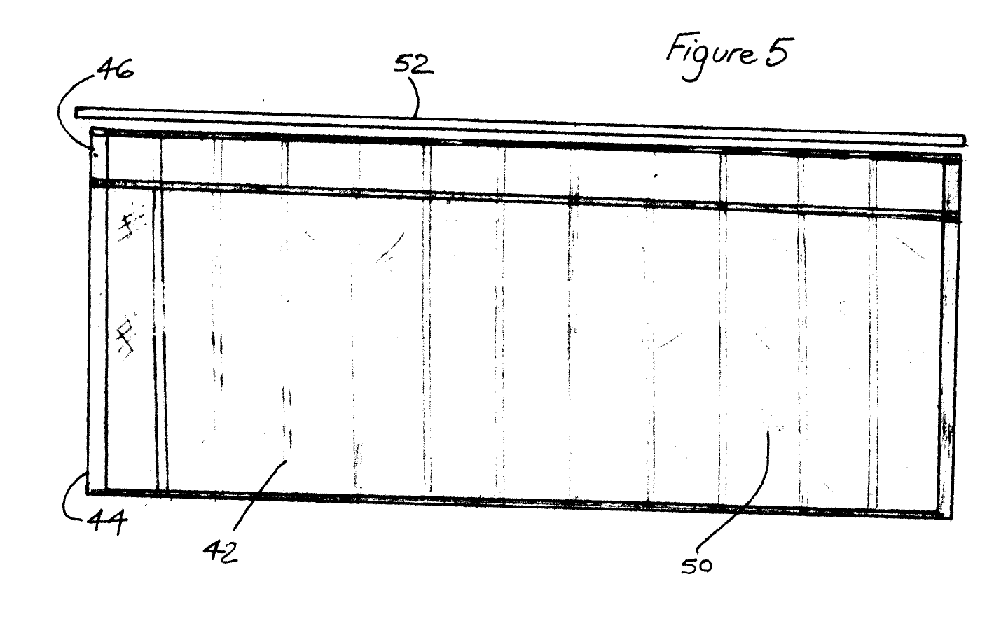

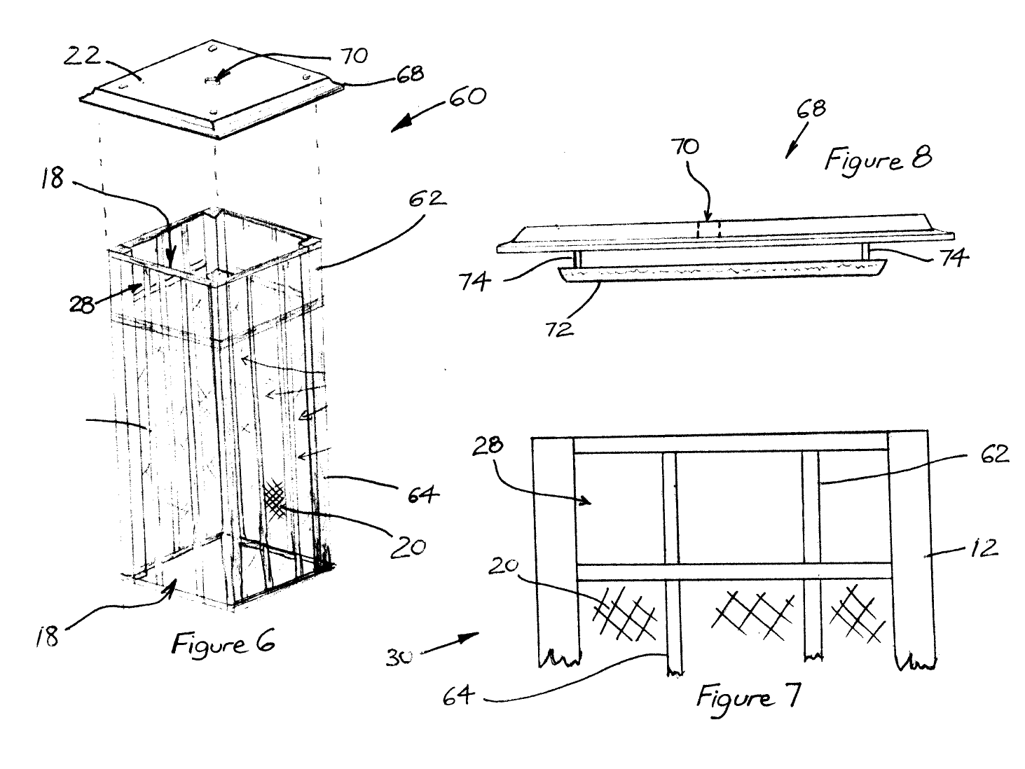

The apparatus 60 shown in FIGS. 6 and 7 is similar to apparatus 10, 30 and 40 in structure and function except that it is a much smaller apparatus that can be used for domestic purposes. The insecticide is supplied from a single spray can and is sprayed in controlled amounts through the nozzle of the can under the control of a timer (not shown). The smaller apparatus 60 also has an upper portion 62 with a height of about 200 mm above ground level, and a lower portion 64 with a depth of about 400 mm below ground level, but its length (as well as its breadth) is only about 300 mm, therefore requiring a much smaller trench to be dug for its installation. Like numbers have been used in FIGS. 6 and 7 to indicate like features with the apparatus shown in FIG. 1.

FIG. 8 shows a lid 68 that may be used in the apparatus 10, 30, 40 or 60. The lid 68 has a hole 70 formed therethrough, and there is a tray 72 mounted in spaced apart relationship by arms 74 beneath the lid for capturing and pooling any water that passes through the hole. The water in the tray 72 serves to attract any flying insects, such as mosquitoes, into the in-ground enclosure 18.

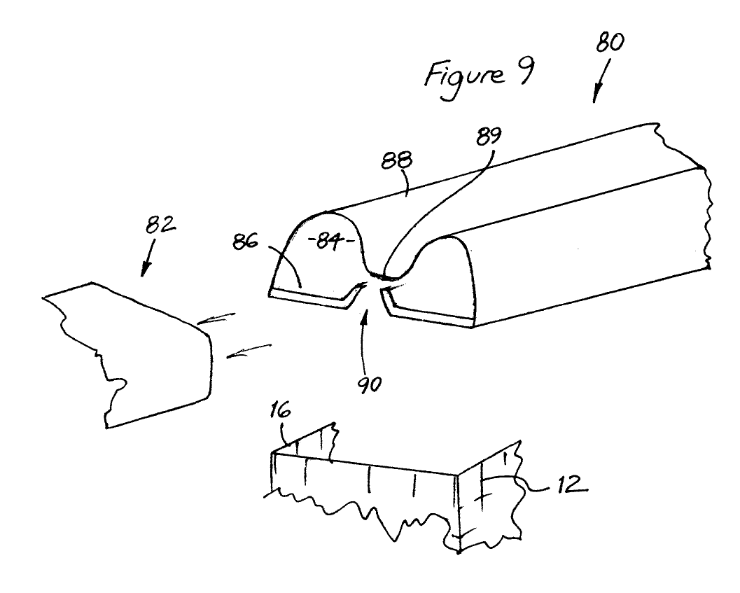

FIG. 9 shows a lid 80 and suction device 82 that may be used in the apparatus 10, 30, 40 or 60. The lid 80 comprises a compartment 84 having a floor 86 and a roof 88, the sides of which extend upwardly from the outer edges of the floor and then meet across a valley shaped region 89. The floor 86, which is preferably black so as to attract certain flying insects, such as march flies, has an opening 90 formed therethrough to allow access of flying insects from the upper portion 16 into the compartment 84. The opening 90, which is below the valley shaped region 89, is defined by a converging passageway from the upper portion 16 to the compartment 84. The roof 88 is transparent. Any flying insects that enter the compartment 84 are trapped therein and will die. The lid 80 may replace or augment the insecticide spraying means as a means by which any flying insects are killed by the apparatus of the invention.

The lid 80 is operatively associated with the suction device 82 or blower to remove dead or trapped insects from within the compartment 84. The suction device 82 vacuums out the insects from the compartment to a remote disposal location.

It will be apparent from the above descriptions of the apparatus 10, 30, 40 and 60 that the use of these apparatus can provide an environmentally safe, effective and easy to install method of killing flying insects, such as sand flies, that can be employed by local communities at minimum cost.

The method comprises the following steps (a) providing an open framework 12 having a lower portion 14 adapted to be located under ground level, and an upper portion 16 adapted to be located above ground level and which is continuous with the lower portion and has a lid 22 for covering the top of the upper portion, the lower portion of the open framework including a mesh 20 to prevent collapse of the ground into the lower portion, (b) locating the lower portion under ground level so as to define an in-ground enclosure 18, and (c) spraying controlled amounts of insecticide into the in-ground enclosure. By this method, flying insects, such as sand flies and mosquitoes, which gain access into the in-ground enclosure by entering through an opening 28 in the open framework at the sides of the upper portion are killed by exposure to sprayed insecticide.

In an alternative embodiment of the method of the invention, the use of the lid 80 may replace or augment the use of insecticide spray as a means by which any flying insects are killed by the apparatus of the invention.

It will also be apparent to persons skilled in the art that, in alternative embodiments, the open framework may be triangular shaped, circular shaped, trapezoidal shaped, kite shaped, etc.

Furthermore, it will be apparent to persons skilled in the art that the components of the apparatus of the invention as described above may be made of a variety of strong, lightweight and durable materials.

Various advantages of the present invention over the prior art will be readily apparent from the above description.

One advantage is that the apparatus, when installed in a trench, appears to take advantage of the characteristic of sand flies to swarm into the so formed in-ground enclosure, perhaps attracted into the trench for purposes of breeding and protection. Such protection from sun, rain and other threats is further facilitated by the lid.

Another advantage is that the apparatus is largely hidden from view and, although it is installed in a trench dug in the ground, no person can fall into it and the pesticide is released controllably within the in-ground enclosure. Also, only small amounts of insecticide need to be sprayed into the enclosure, because flying insects are attracted into, and thereby concentrated in large numbers within, the trench.

Yet another advantage is that the mesh allows the insects to access the soil. By holding back the soil and preventing its collapse into the in-ground enclosure, the soil can remain damp, thus maintaining a high level of humidity in the enclosure and of stability of the surrounding ground.

It will also be readily apparent to persons skilled in the art that various modifications may be made in details of design and construction of the embodiments of the apparatus, and in the steps of using the apparatus described above, without departing from the scope or ambit of the present invention.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates before the filing date of this patent application.

1. An apparatus for killing flying insects comprising an open framework having a lower portion adapted to be located under ground level so as to define an in-ground enclosure, and an upper portion which is adapted to be located above ground level and is continuous with the lower portion, the lower portion of the open framework including a mesh to prevent collapse of the ground around the enclosure, means for spraying controlled amounts of insecticide into the in-ground enclosure, and a lid for covering the top of the upper portion, wherein flying insects, such as sand flies and mosquitoes, may gain access into the in-ground enclosure by entering through an opening in the open framework at the sides of the upper portion, whereby any flying insects within the in-ground enclosure are killed by exposure to sprayed insecticide.

2. The apparatus of claim 1 wherein the insecticide is supplied to the spraying means through a pipe feeding from a pressurized insecticide storage vessel.

3. The apparatus of claim 2 wherein the insecticide is sprayed in controlled amounts through one or more nozzles located along a portion of the pipe inside the in-ground enclosure under the control of a timer.

4. The apparatus of claim 1 wherein the insecticide is supplied from a single spray can and sprayed in controlled amounts through the nozzle of the can under the control of a timer.

5. The apparatus of claim 3 wherein the timer is adjustable by the user.

6. The apparatus of claim 5 wherein the insecticide is sprayed as a mist from the or each nozzle.

7. The apparatus of claim 1 and further including at least one form of an attractant for flying insects.

8. The apparatus of claim 1 wherein the lid comprises a compartment having a floor and a roof extending upwardly from the sides of the floor, the floor having an opening formed therethrough to allow access of flying insects from the upper portion into the compartment, the roof being transparent, whereby any flying insects within the compartment are trapped therein and will die.

9. The apparatus of claim 8 wherein the sides of the roof extend upwardly from the outer edges of the floor and then meet across a valley shaped region.

10. The apparatus of claim 8 wherein the opening is defined by a converging passageway from the upper portion to the compartment.

11. A method for killing flying insects, comprising:
(a) providing an open framework having a lower portion adapted to be located under ground level, and an upper portion adapted to be located above ground level and which is continuous with the lower portion and has a lid for covering the top of the upper portion, the lower portion of the open framework including a mesh to prevent collapse of the ground into the lower portion,
(b) locating the lower portion under ground level so as to define an in-ground enclosure, and
(c) spraying controlled amounts of insecticide into the in-ground enclosure, wherein flying insects, such as sand flies and mosquitoes, which gain access into the in-ground enclosure by entering through an opening in the open framework at the sides of the upper portion are killed by exposure to sprayed insecticide.
